(19) United States
(12) Patent Application Publication
(10) Pub. No.: US 2019/0253357 A1
(43) Pub. Date: Aug. 15, 2019

(54) LOAD BALANCING BASED ON PACKET PROCESSING LOADS

(71) Applicant: Intel Corporation, Santa Clara, CA (US)

(72) Inventors: Pravin PATHAK, Bridgewater, NJ (US); Sundar VEDANTHAM, Allentown, PA (US); David SONNIER, Austin, TX (US)

(21) Appl. No.: 16/160,096

(22) Filed: Oct. 15, 2018

(51) Int. Cl. H04L 12/803; H04L 12/863; H04L 12/851

(52) U.S. Cl. CPC H04L 47/125; H04L 47/622; H04L 47/6215; H04L 47/624; H04L 47/2441; H04L 47/6255

(57) ABSTRACT

A computing platform includes a classifier to classify a packet and assign a processing load weight to the packet based at least in part on the packet classification; and a load balancer coupled to the classifier to compute a total processing load weight of a queue of a packet processing system and assign the packet to a queue with a lowest total processing load weight.

### BACKGROUND

Packet processing systems typically provision a number of “worker” processing threads running on processor cores (sometimes called “worker cores”) to perform the processing work of packet processing applications. Worker cores consume packets from dedicated queues which in some scenarios is fed by one or more network interface controllers (NICs), by input/output (I/O) threads, or by other processing threads.

Load balancers typically make decisions about processor core workload and where to add packets to queues based on the current length of the queue(s) being serviced by a core (e.g., length being measured by the number of packets in the queue(s) to be processed). Another approach is to make the decisions based on the total number of bytes of packets in each queue. A load balancer typically schedules the next packet to a queue with the least number of packets or bytes. Some packets could result in higher workloads, thereby taking longer times to process. The assumption that processing workloads is proportional to the number of packets in the queue and/or the total number of bytes in packets in the queue is not necessarily true. The load balancer has no information about the actual time anticipated to process the packets in a queue. If load balancing for the packet processing system is done solely based on queue lengths or number of bytes of packets in the queue, multiple high workload packets can get scheduled onto a shorter length/smaller byte count queue. Any subsequent packets (especially including time sensitive packets) now getting scheduled to this queue due to the queue's shorter length/smaller byte count may face increased latency. This results in occasional spikes in latency experienced in the packet processing system.

### BRIEF DESCRIPTION OF THE DRAWINGS

FIG. 1 illustrates an example computing system.

FIG. 2 illustrates an example arrangement of processing cores.

FIG. 3 illustrates an example hardware queue manager (HQM).

FIG. 4 illustrates an example packet and packet metadata including a processing weight field.

FIG. 5 illustrates an example diagram of a load balancing system.

FIG. 6 illustrates an example flow diagram of a process to balance workloads in a packet processing system.

FIG. 7 illustrates an example of a storage medium.

FIG. 8 illustrates another example computing platform.

### DETAILED DESCRIPTION

Embodiments of the present invention provide an approach for load balancing of processing cores. Embodiments provide for packet processing applications to identify and/or mark packets with an associated processing load factor called a processing weight herein. In an embodiment, the processing weight field is included in packet metadata. With this added processing weight field, a load balancer makes better packet scheduling decisions based at least in part on actual or anticipated processing loads of packets waiting in queues instead of assuming core workloads are proportional to current sizes of queues (e.g., either lengths or byte counts) assigned to the cores. This results in better overall system latency times and improved core utilization. Embodiments can be used in deploying “cloudified” applications in data center systems that can scale up and down in size and provide more efficient packet processing operations.

Embodiments of the present invention leverage a load balancing capability of a hardware queue manager (HQM) to assign packets to queues based at least in part on processing weights of packets to improve efficiency while maintaining performance (e.g., throughput and latency) requirements. A worker thread is a consumer from the HQM and packet processing work is distributed amongst the worker threads on the worker cores based at least in part on the processing weight factor.

Although the data units being processed in embodiments of the present invention are described as packets and associated packet metadata, the concepts described herein are also applicable to any data units (e.g., bitstreams of data) or tasks to be processed by a computing platform.

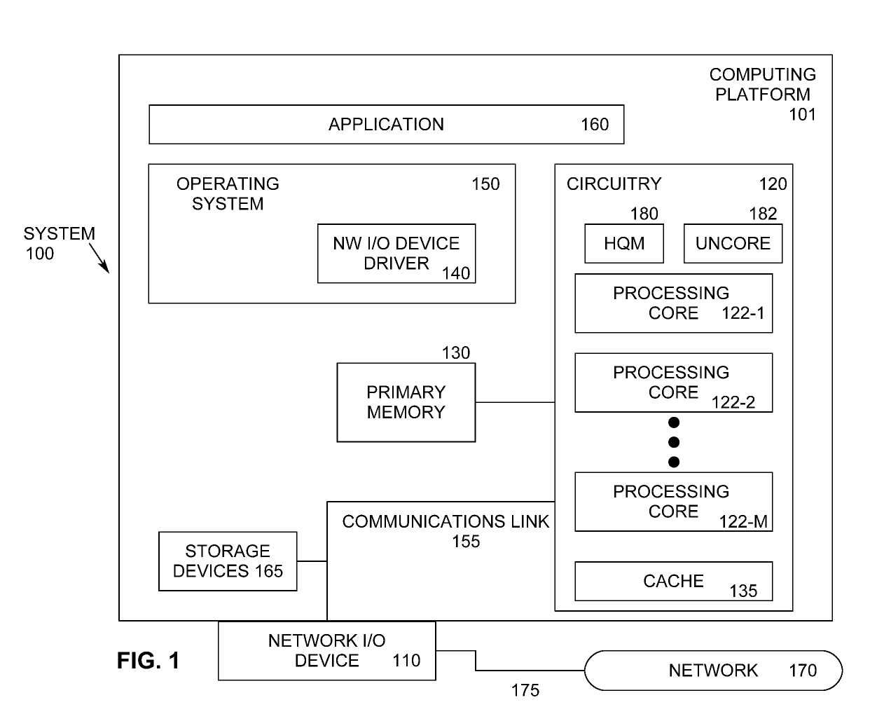

FIG. 1 illustrates an example computing system 100. As shown in FIG. 1, computing system 100 includes a computing platform 101 coupled to a network 170 (which may be the Internet, for example). In some examples, as shown in FIG. 1, computing platform 101 is coupled to network 170 via network communication channel 175 and through at least one network I/O device 110 (e.g., a network interface controller (NIC)) having one or more ports connected or coupled to network communication channel 175. In an embodiment, network communication channel 175 includes a PHY device (not shown). In an embodiment, network I/O device 110 is an Ethernet NIC. Network I/O device 110 transmits data packets from computing platform 101 over network 170 to other destinations and receives data packets from other destinations for forwarding to computing platform 101.

According to some examples, computing platform 101, as shown in FIG. 1, includes circuitry 120, primary memory 130, network (NW) I/O device driver 140, operating system (OS) 150, at least one application 160, and one or more storage devices 165. In one embodiment, OS 150 is Linux™. In another embodiment, OS 150 is Windows® Server. Network I/O device driver 140 operates to initialize and manage I/O requests performed by network I/O device 110. In an embodiment, packets and/or packet metadata to be transmitted to network I/O device 110 and/or received from network I/O device 110 are stored in one or more of primary memory 130 and/or storage devices 165. In at least one embodiment, application 160 is a packet processing application. In another embodiment, application 160 is a virtual switch. In at least one embodiment, storage devices 165 may be one or more of hard disk drives (HDDs) and/or solid-state drives (SSDs). In an embodiment, storage devices 165 may be non-volatile memories (NVMs). In some examples, as shown in FIG. 1, circuitry 120 is communicatively coupled to network I/O device 110 via communications link 155. In one embodiment, communications link 155 is a peripheral component interface express (PCIe) bus conforming to version 3.0 or other versions of the PCIe standard published by the PCI Special Interest Group (PCI-SIG). In some examples, operating system 150, NW I/O device driver 140, and application 160 are implemented, at least in part, via cooperation between one or more memory devices included in primary memory 130 (e.g., volatile or non-volatile memory devices), storage devices 165, and elements of circuitry 120 such as processing cores 122-1 to 122-m, where “m” is any positive whole integer greater than 2. In an embodiment, OS 150, NW I/O device driver 140, and application 160 are executed by one or more processing cores 122-1 to 122-m.

In some examples, computing platform 101, includes but is not limited to a server, a server array or server farm, a web server, a network server, an Internet server, a work station, a mini-computer, a main frame computer, a supercomputer, a network appliance, a web appliance, a distributed computing system, multiprocessor systems, processor-based systems, a laptop computer, a tablet computer, a smartphone, or a combination thereof. In one example, computing platform 101 is a disaggregated server. A disaggregated server is a server that breaks up components and resources into subsystems and connects them through network connections. Disaggregated servers can be adapted to changing storage or compute loads as needed without replacing or disrupting an entire server for an extended period of time. A server could, for example, be broken into modular compute, I/O, power and storage modules that can be shared among other nearby servers.

Circuitry 120 having processing cores 122-1 to 122-m may include various commercially available processors, including without limitation Intel® Atom®, Celeron®, Core (2) Duo®, Core i3, Core i5, Core i7, Itanium®, Pentium®, Xeon® or Xeon Phi® processors, ARM processors, AMD processors, and similar processors. Circuitry 120 may include at least one cache 135 to store data.

Uncore 182 describe functions of a processor that are not in processing cores 122-1, 122-2, . . . 122-m, but which are closely connected to the cores to achieve high performance. Cores contain components of the processor involved in executing instructions, including the arithmetic logic unit (ALU), the floating-point unit (FPU) and level one and level two caches. In contrast, in various embodiments, uncore 182 functions include interconnect controllers, a level three cache, a snoop agent pipeline, an on-die memory controller, and one or more I/O controllers. In an embodiment, uncore 182 is resident in circuitry 120. In an embodiment, uncore 182 includes last level cache 135.

According to some examples, primary memory 130 may be composed of one or more memory devices or dies which may include various types of volatile and/or non-volatile memory. Volatile types of memory may include, but are not limited to, dynamic random-access memory (DRAM), static random-access memory (SRAM), thyristor RAM (TRAM) or zero-capacitor RAM (ZRAM). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magneto-resistive random-access memory (MRAM) that incorporates memristor technology, spin transfer torque MRAM (STT-MRAM), or a combination of any of the above. In another embodiment, primary memory 130 may include (but is not limited to) one or more hard disk drives within and/or accessible by computing platform 101.

Computing platform 101 includes hardware queue manager (HQM) 180 to assist in managing queues of data units such as packets and/or packet metadata. In an embodiment, the data units are packets to be transmitted to and/or received from network I/O device 110, and also packets exchanged between cores. In another embodiment, the data units include timer events. In an embodiment, HQM 180 is part of circuitry 120. In another embodiment, HQM 180 is part of uncore 182.

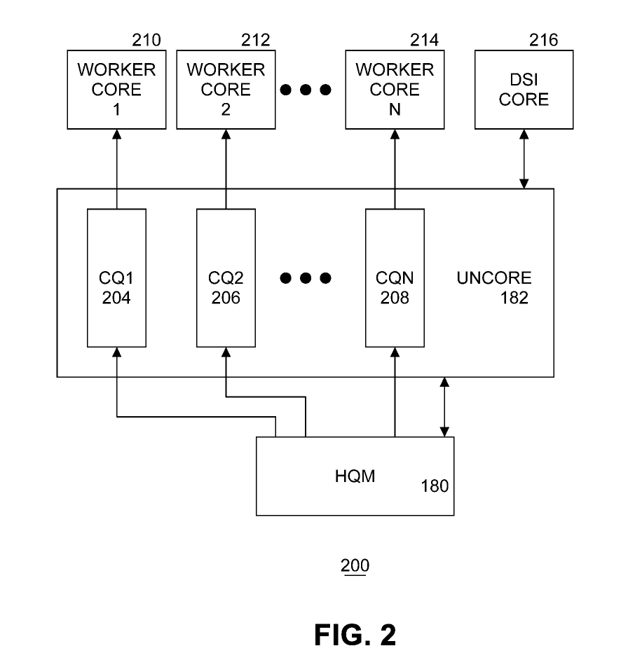

FIG. 2 illustrates an example arrangement 200 of processing cores. Arrangement 200 includes a plurality of worker cores 1 210, 2 212, . . . N 214, where N is a natural number. One embodiment of the present invention uses a loop running on a receive (Rx) device specific interface (DSI) core 216 to control load balancing for processing of received packets. DSI core 216 may also be known as a load balancing core. A process executing on DSI core 216 monitors the traffic load incoming from network I/O device 110 to determine assignments of packets to queues. In an embodiment, DSI core 216 makes network I/O device 110 resemble a software agent to HQM 180. DSI core 216 accepts descriptors (e.g., metadata) for incoming packets and enqueues the packet descriptors in queues in HQM 180 for load balancing. In embodiments of the present invention, DSI core 216 and worker cores 210, 212, . . . 214 are processing cores 122-1, 122-2, . . . 122-m as described FIG. 1. In one embodiment, worker cores go into and out of sleep state using a MWAIT instruction (for computing platforms having an Intel Architecture instruction set architecture (ISA)) when no work is available.

In an embodiment, uncore 182 includes a plurality of consumer queues CQ 1 204, CQ 2 206, . . . CQ N 208, where N is a natural number, stored in cache 135. Each consumer queue stores zero or more blocks of metadata. In an embodiment, a block of metadata is a packet descriptor including information describing a packet. In one embodiment, there is a one to one correspondence between each worker core and a consumer queue. For example, worker core 1 210 is associated with CQ 1 204, worker core 2 212 is associated with CQ 2 206, and so on until worker core N 214 is associated with CQ N 208. However, in other embodiments there may be a plurality of consumer queues per worker core. In yet another embodiment, at least one of the worker cores is not associated with a consumer queue. The sizes of the consumer queues may all be the same or may be different in various embodiments. The sizes of the consumer queues are implementation dependent. In at least one embodiment, the consumer queues store metadata describing packets, but not the packets themselves (since the packets are stored in one or more of primary memory 130, cache 135, and storage devices 165 while being processed after receipt from network I/O device 110). In an embodiment, the metadata includes a processing weight field for each packet.

HQM 180 distributes packet processing tasks to enabled worker cores 210, 212, . . . 214 by adding packet descriptors to consumer queues CQ 1 204, CQ 2 206, . . . CQ N 208 in uncore 182. HQM 180 acts as a traffic buffer smoothing out spikes in traffic flow. HQM 180 performs load balancing while considering flow affinity. Disabled worker cores are not allocated any traffic when disabled and can enter low power states semi-statically, or be switched to other duties.

In an embodiment, processing proceeds as follows. DSI core 216 enqueues packet descriptors (e.g., packet metadata) to HQM 180 via uncore 182. HQM 180 distributes (i.e., load balances) packet descriptors to active consumer queues CQ1 204, CQ 2 206, . . . CQ N 208 in uncore 182, based at least in part on processing weight fields of packets. Worker cores 210, 211, . . . 214 get packet descriptors from corresponding consumer queues for packet processing. Worker cores with nothing to do (i.e., there are no packet descriptors in their consumer queues to be processed), go to sleep.

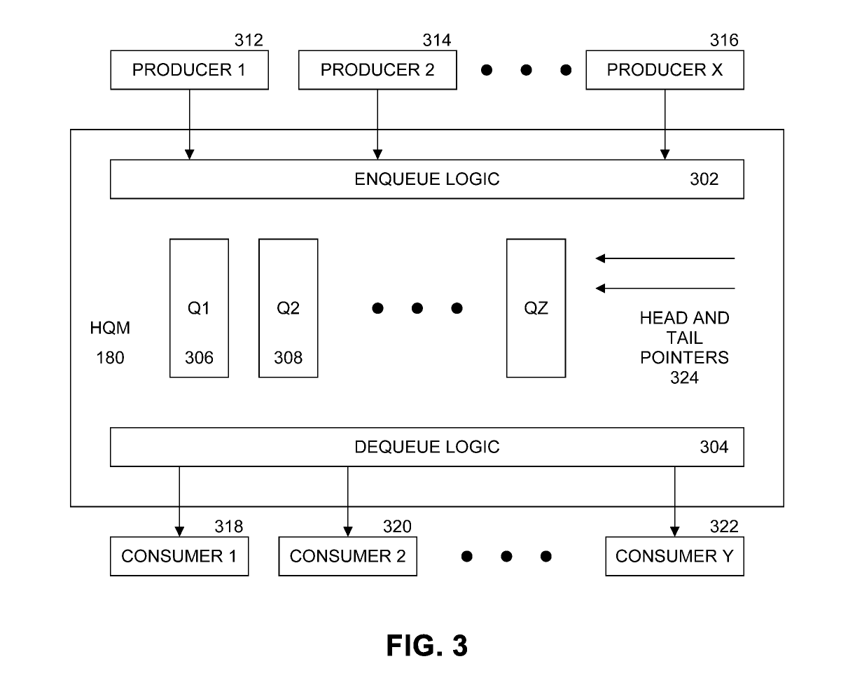

FIG. 3 illustrates an example hardware queue manager (HQM) 180. HQM provides queue management offload functions and load balancing services. HQM 180 provides a hardware managed system of queues and arbiters connecting producers and consumers. HQM 180 includes enqueue logic circuitry 302 to receive data (such as packet descriptors/metadata for example) from a plurality of producers, such as producer 1 312, producer 2 314, . . . producer X 316, where X is a natural number. Enqueue logic circuitry 302 inserts the data into one of the queues internal to HQM called Q1 306, Q2 308, . . . QZ 310, where Z is a natural number, for temporary storage during load balancing operations. HQM 180 uses a plurality of head and tail pointers 324 to control enqueuing and dequeuing of data in queues Q1 306, Q2 308, . . . QZ 310. HQM 180 includes dequeue logic circuitry 304 to remove the data from a queue and transfer the data to a selected one of consumer 1 318, consumer 2 320, . . . consumer Y, where Y is a natural number. In an embodiment, the values for X, Y, and Z are different, any one or more producers write to more than one queue, any one or more consumers read from more than one queue, and the number of queues is implementation dependent. Further details on the operation of HQM 180 are described in the commonly assigned patent application entitled “Multi-Core Communication Acceleration Using Hardware Queue Device” filed Jan. 4, 2016, published Jul. 6, 2017 as US 2017/0192921 A1, incorporated herein by reference.

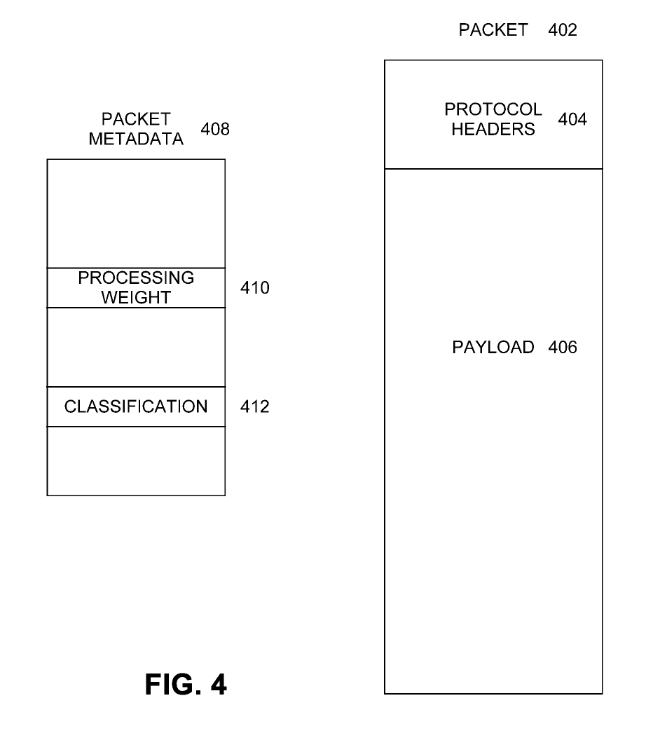

FIG. 4 illustrates example packet 402 and packet metadata 408 including a processing weight field 410. Packet 402 includes protocol headers 404 and payload 406. In an embodiment, an additional field called processing weight 410 is added to a packet's metadata 408. This field indicates the intensity of the processing load on the computing platform expected to be incurred by processing the packet. The precision and range of the processing weight could vary based on the implementation. In one embodiment, processing weight is a natural number. In another embodiment, the processing weight field is stored in protocol headers field 404 of packet 402, instead of in packet metadata 408. In an embodiment, packet metadata 408 also includes a classification field 412 to store classification information about the packet. In one example, classification field 412 stores a type or group of packets, which may be associated with a computed or predetermined processing weight. For example, packets for routine data may be classified as a normal load, packets for periodic system health checks may be classified as a moderate load, packets for periodic statistics collection may be classified as a high load, and packets for new flow setup may be classified as high load. Types or groups of packets are implementation dependent. In one embodiment, example bit values could be 00 (for timer expiration), 01 (for packets meant to be forwarded after header update), 10 (for packets with data that has to be inspected for a signature as in deep packet inspection) and 11 (for packets containing data that has to be processed by digital signal processing (DSP) algorithms). Each one of these four example types will require increasing amounts of processing load. There could be other types in different implementations.

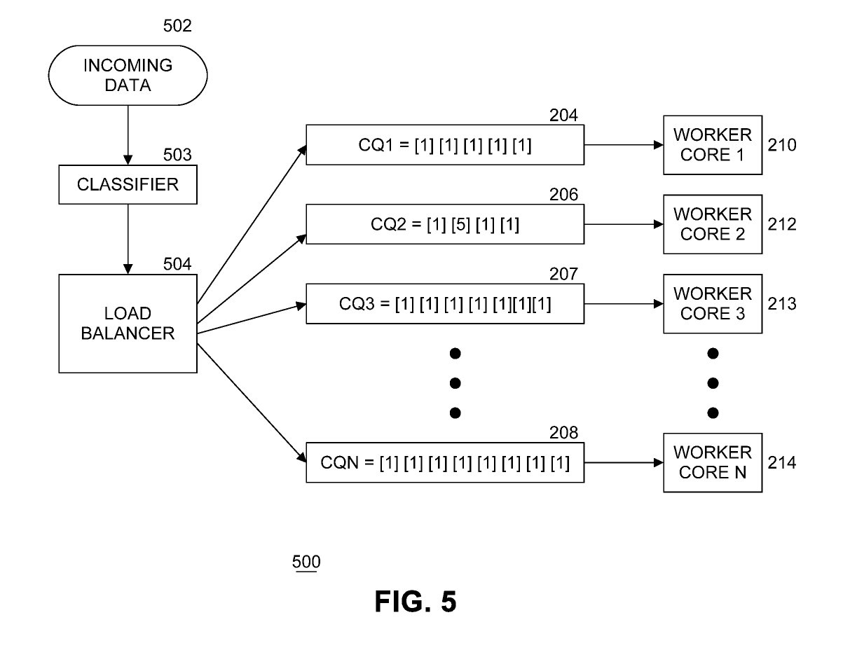

FIG. 5 illustrates an example diagram of a load balancing system 500. In an embodiment, load balancer 504 is implemented as software running on DSI core 216. In another embodiment, load balance 504 is implemented in hardware circuitry within HQM 180. In a still further embodiment, load balancer 504 is implemented in hardware circuitry within uncore 182. In yet another embodiment, load balancer 504 is implemented in software running on one of the worker cores.

In an embodiment, classifier 503 is implemented as software running on DSI core 216. In another embodiment, classifier 503 is part of application 160 (running on any core of the packet processing system), when application 160 generates or forwards data units, such as packets, from one application to another application (whether running on the same core or a different core). In a further embodiment, classifier 503 is implemented in hardware circuitry as part of HQM 180. In yet another embodiment, classifier 503 is implemented in hardware circuitry as part of network I/O device 110, when network I/O device processes newly arrived data packets from network 170.

The entity within the packet processing system that sets the processing weight of a packet is implementation dependent. In various embodiments, the entity is application 160, an external application that sent the packet, network I/O device 110, an operating system (OS), a network interface controller (NIC) driver software, other entities across network 170, or classifier 503. Classifier 503 receives incoming data 502 (such as packets) and classifies the data before forwarding the data to load balancer 504. In an embodiment, an application 160 generating or forwarding the packet can set the processing weight of the packet. The factors and/or information used in setting the processing weight is implementation dependent and may vary across packet processing systems. Generally, the factors and/or information can include any data allowing data units such as packets to be typed or grouped based at least in part on known and/or anticipated processing loads when packets are processed by cores. For example, one factor could be processing time to process a packet on a core. Application 160 can determine which packets will trigger a high processing load and can adjust the processing weight of packets accordingly. The processing weight field in packet metadata can also be added/modified before sending or forwarding such packets. In another embodiment, network I/O device 110 and/or network I/O device driver 140 can set the processing weight of packets received from network 170 based at least in part on application-configured lookup tables (not shown in FIG. 5). In an embodiment, the values in application-configured lookup tables can be set by a user (such as a system administrator) via application 160.

When a packet is received, classifier 503 classifies the packet, assigns a classification value and stores the classification value in classification field 412 of packet metadata 408. Based at least in part on the classification, classifier 503 assigns a processing weight for the packet and stores the processing weight in processing weight field 410 of packet metadata 408. In an embodiment, classifier 503 adjusts the processing weight based at least in part on packet type using an application-configured lookup table (not shown in FIG. 5). In an embodiment, the processing weight may be stored inside packet payload 406 where the load balancer 504 knows the configurable offset within payload 406 in order to access the processing weight. If a packet is generated by an application 160 in the packet processing system (instead of received from outside the system), the application can estimate the expected load each packet is going to generate and can set the processing weights accordingly.

Load balancer 504 generates an estimate of total processing load of a queue by considering associated packet processing weights. In embodiments of the present invention, load balancer 504 load balances based at least in part on this processing weight load estimate instead of based on queue lengths or byte counts. The entity within the packet processing system that implements load balancer is implementation dependent. In various embodiments, the entity is application 160, an external application that sent the packet, network I/O device 110, an operating system (OS), a network interface controller (NIC) driver software, other entities across network 170, or classifier 503.

In one embodiment, each packet can carry a default processing weight of 1 and thus the packet processing system will behave identically to current load balancers. (e.g., the total processing weight of a queue equals the number of packets in the queue). In other embodiments, other default processing weight values may be used.

Processing intensive packets are assigned a processing weight greater than 1. This will result in the queue holding these packets as being viewed as having a higher total processing weight estimate compared to other queues holding the same number of default processing weight packets (i.e., packets with processing weights of 1). Load balancer 504 will automatically reduce packet flow to the queues with high processing weight packets, thereby resulting in lower latencies and fairer load balancing for the entire packet processing system.

There are some packets which can trigger events like statistic collections, periodic cleanup, maintenance, etc., which are time consuming activities. To promote greater efficiency in the packet processing system, when these packets are queued, other packets are not added to those queues until they are consumed since the potential for newly added packets to those queues experiencing a larger latency is high. This scenario cannot be avoided with a queue length-based or byte-based load balancer. In embodiments of the present invention, a large processing weight can be added to such packets, effectively stopping any further scheduling to those queues until the high processing weight packets have been consumed.

In an embodiment, classifier 503 is included in the packet processing system to classify packets based on type of application and assign or modify processing weights based at least in part on packet type. In this embodiment, the application provides the packet type information to the classifier to aid in processing load mapping of packets to queues.

In case of atomic flows, if a flow is locked to a core, then load balancing is not done based on queue processing weights. Instead, the atomic flow's affinity to the locked core is used for scheduling. If atomic flow is unlocked, then queue processing weights can be used to switch a packet flow to queue for a new core with a lower processing weight.

Packet re-ordering is performed in a second stage of packet processing where processed packets are enqueued back by the core. Thus, re-ordering is not affected by the present approach. This approach helps in calculating better estimates of queue processing weights for fairer load balancing and lower latencies.

Load balancing is based on computing the processing weight of all packets in each queue. This results in an estimated queue total processing weight. Queues with higher total processing weights will not be allowed to be built up with additional packets as compared to other queues with low total processing weight.

If a queue only has regular packets (processing weight=1), total processing weight will be same as queue length. Thus, if required, an existing packet processing model already in use can be fully supported by embodiments of the present invention.

A large processing weight can be added to a packet to block any more packet scheduling to a queue behind such packets.

In an embodiment, a signal indicating early completion may be sent by a core when the core determines the core is nearing the end of processing of packets in a queue. The core can then drop the extra queue weight early and allow the load balancer to queue more packets to the core's queue.

Load balancer 504 receives incoming data 502 (such as packets and/or associated metadata, for example) from classifier 503. Load balancer 504 determines which queue of consumer queues CQ1 204, CQ2 206, CQ3 207, . . . CQN 208 is to receive a new packet for processing by assigned worker cores 210, 212, 213, . . . 214, respectively.

In this example, CQ1 204 has five entries, each entry having a normal processing weight of 1. Thus, at this point in time CQ 1 204 has a length of 5 and a total processing weight of 5. CQ 2 206 has four entries, with three entries having a normal processing weight and one entry having a processing weight of 5. The packet in the entry with processing weight of 5 is expected to take five times longer to process as compared to a packet with a processing weight of 1. Thus, at this point in time CQ 2 206 has a length of 4 and a total processing weight of 8. CQ 3 207 has seven entries, each entry having a normal processing weight of 1. Thus, at this point in time CQ 3 207 has a length of 7 and a total processing weight of 7. Finally, CQ N 208 has eight entries, each entry having a normal processing weight of 1. Thus, at this point in time CQ N 208 has a length of 8 and a total processing weight of 8. With a traditional queue length-based load balancer, the next packet to be enqueued will get added to CQ 2 206 as this queue has the least number of queue entries (four in this example). But the newly queued packet to CQ 2 206 will experience higher latency because CQ 2 206 already has a packet in the queue with a processing weight of 5, which will take longer to process. With a processing weight-based load balancer of embodiments of the present invention, the next packet will be added to CQ 1 204 instead of CQ 2 206 because CQ 1 204 has a lowest total processing weight (e.g., 4) of any queue. This next packet will experience a lower latency as compared to the traditional queue length-based load balancer.

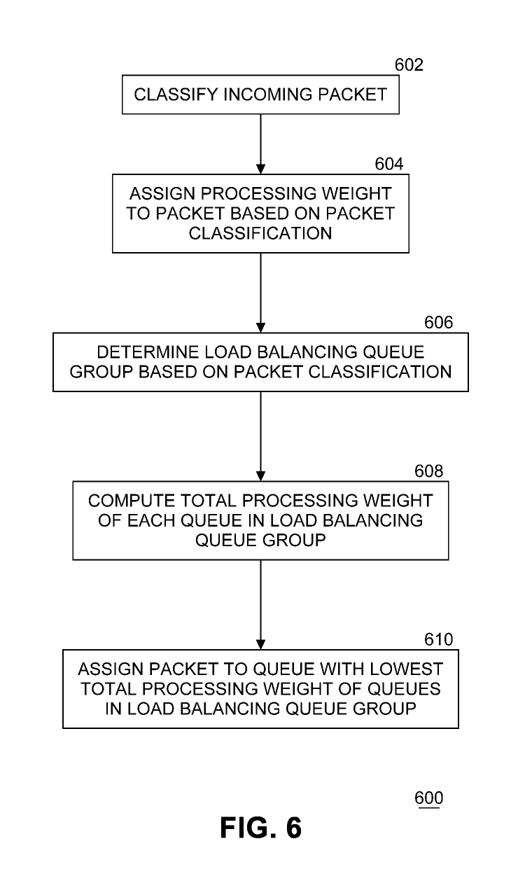

FIG. 6 illustrates an example flow diagram of a process 600 to balance workloads in a packet processing system. As described above, in an embodiment an application-configured lookup table that maps packet classifications (e.g., types and/or groups) to processing weights based on known information about packet processing loads on computing platform 101 is used. At block 602, classifier 503 classifies an incoming packet 502. As part of classification processing, classifier 503 assigns a classification value and stores the classification value in classification field 412 of packet metadata 408. At block 604, classifier 503 assigns a processing weight to the packet based at least in part on the packet classification and stores the processing weight in processing weight field 410 of packet metadata 408. In one embodiment, classifier searches the application-configured lookup table and selects the processing weight associated with the packet classification.

In one embodiment, at block 606, classifier 503 determines a load balancing queue group based at least in part on the packet classification. In one embodiment, a load balancing queue group is a collection of queues (i.e., CQs 204, 206, 207, . . . 208) grouped together. In one embodiment, every packet that needs load balancing is mapped to a queue group (e.g., a group of consumer queues to which the packet needs to be load balanced). A queue group is defined by an identification number which corresponds to group of consumer queues. When a configuration is one consumer queue per core, a queue group maps to load balancing across associated cores. A queue group is configured by the application. Classifier performs the classification operation and based on the classification, the packet is assigned to a particular queue group inside load balancer.

It is a common practice in some computing systems to limit certain packet processing to a subset of available cores. This is typically done using core masks. In some cases, the behavior of a subset of queues is different (atomic vs. ordered vs. unordered queues). Thus, it may be desirable to form a queue group to process a set of queues together.

In one embodiment, load balancing queue groups are omitted, and all queues are considered individually.

At block 608, load balancer 504 computes a total processing weight of each queue in a load balancing queue group. The total processing weight of a queue is the sum of the processing weights of all packets in the queue. At block 610, load balancer assigns the packet to the queue with the lowest total processing weight in the load balancing queue group.

In one embodiment, blocks 602 through 610 are performed in sequence for each received packet. In another embodiment, blocks 602-606 of classifier 503 are processed repeatedly (i.e., as each packet is received) independently and in parallel of blocks 608-610 of load balancer 504. In this case, load balancer 504 assigns a plurality of packets to queues in a “batch” mode, handling a plurality of packets at a time independently of classifier 503 classifying packets.

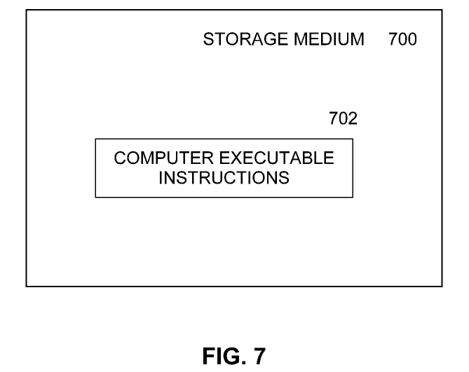

FIG. 7 illustrates an example of a storage medium 700. Storage medium 700 may comprise an article of manufacture. In some examples, storage medium 700 may include any non-transitory computer readable medium or machine readable medium, such as an optical, magnetic or semiconductor storage. Storage medium 700 may store various types of computer executable instructions, such as instructions 702 to implement logic flow 600 of FIG. 6. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

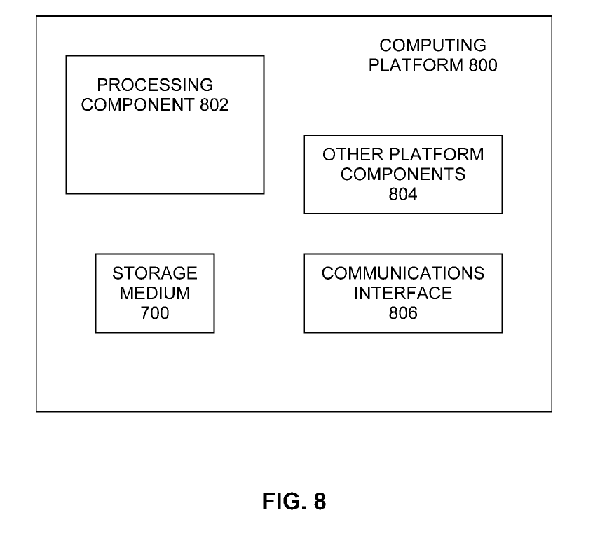

FIG. 8 illustrates an example computing platform 800. In some examples, as shown in FIG. 8, computing platform 800 may include a processing component 802, other platform components 804 and/or a communications interface 806.

According to some examples, processing component 802 may execute processing operations or logic for instructions stored on storage medium 700. Processing component 802 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 804 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3-D cross-point memory that may be byte or block addressable. Non-volatile types of memory may also include other types of byte or block addressable non-volatile memory such as, but not limited to, multi-threshold level NAND flash memory, NOR flash memory, single or multi-level PCM, resistive memory, nanowire memory, FeTRAM, MRAM that incorporates memristor technology, STT-MRAM, or a combination of any of the above. Other types of computer readable and machine-readable storage media may also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 806 may include logic and/or features to support a communication interface. For these examples, communications interface 806 may include one or more communication interfaces that operate according to various communication protocols or standards to communicate over direct or network communication links or channels. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Switch Specification.

The components and features of computing platform 800, including logic represented by the instructions stored on storage medium 700 may be implemented using any combination of discrete circuitry, ASICs, logic gates and/or single chip architectures. Further, the features of computing platform 800 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 800 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASIC, programmable logic devices (PLD), digital signal processors (DSP), FPGA, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Included herein are logic flows or schemes representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow or scheme may be implemented in software, firmware, and/or hardware. In software and firmware embodiments, a logic flow or scheme may be implemented by computer executable instructions stored on at least one non-transitory computer readable medium or machine readable medium, such as an optical, magnetic or semiconductor storage. The embodiments are not limited in this context.

Some examples are described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
classifying a packet;
assigning a processing load weight to the packet based at least in part on the packet classification;
computing a processing load weight of each queue of a packet processing system; and
assigning the packet to a queue with a lowest processing load weight.

2. The method of claim 1, wherein the processing load weight of a queue is a sum of processing weights of packets in the queue.

3. The method of claim 1, comprising
determining a group of queues based at least in part on the packet classification;
computing a processing load weight of a queue in the group of queues; and
assigning the packet to the queue in the group of queues with the lowest processing load weight.

4. The method of claim 1, comprising performing classifying the packet and assigning the processing load weight to the packet in parallel with performing computing the processing load weight of a queue and assigning the packet to the queue with the lowest processing load weight.

5. The method of claim 1, comprising storing the packet classification and the processing load weight of the packet in packet metadata.

6. The method of claim 1, comprising assigning the processing load weight to the packet by searching a lookup table that maps packet classifications to processing load weights and selecting the processing load weight associated with the packet classification in the lookup table.

7. At least one tangible machine-readable medium comprising a plurality of instructions that in response to being executed by a processor cause the processor to:
classify a packet;
assign a processing load weight to the packet based at least in part on the packet classification;
compute a total processing load weight of a queue of a packet processing system; and
assign the packet to a queue with a lowest processing load weight.

8. The at least one tangible machine-readable medium of claim 7, wherein the processing load weight of a queue is a sum of processing load weights of packets in the queue.

9. The at least one tangible machine-readable medium of claim 7, comprising instructions to
determine a group of queues based at least in part on the packet classification;
compute a total processing load weight of a queue in the group of queues; and
assign the packet to the queue in the group of queues with the lowest processing load weight.

10. The at least one tangible machine-readable medium of claim 7, comprising instructions to perform classifying the packet and assigning the processing load weight to the packet in parallel with instructions to perform computing the processing load weight of a queue and assigning the packet to the queue with the lowest processing load weight.

11. The at least one tangible machine-readable medium of claim 7, comprising instructions to store the packet classification and the processing load weight of the packet in packet metadata.

12. The at least one tangible machine-readable medium of claim 7, wherein instructions to assign the processing load weight to the packet comprise instructions to search a lookup table that maps packet classifications to processing load weights and select the processing load weight associated with the packet classification in the lookup table.

13. A system comprising:
a classifier to classify a packet and assign a processing load weight to the packet based at least in part on the packet classification; and
a load balancer coupled to the classifier to compute a processing load weight of a queue of a packet processing system and assign the packet to a queue with a lowest processing load weight.

14. The system of claim 13, wherein the processing load weight of a queue is a sum of processing load weights of packets in the queue.

15. The system of claim 13, comprising the classifier to determine a group of queues based at least in part on the packet classification, and the load balancer to compute a processing load weight of each queue in the group of queues, and assign the packet to the queue in the group of queues with the lowest processing load weight.

16. The system of claim 13, comprising the classifier and the load balancer configured to operate in parallel.

17. The system of claim 13, comprising the classifier to store the packet classification and the processing load weight of the packet in packet metadata.

18. The system of claim 13, wherein the classifier to assign the processing load weight to the packet comprises the classifier to search a lookup table that maps packet classifications to processing load weights and select the processing load weight associated with the packet classification in the lookup table.
